(19) United States
(12) Patent Application Publication
(10) Pub. No.: US 2007/0224437 A1
(43) Pub. Date: Sep. 27, 2007

(54) Laminated packaging film and method of producing same

(76) Inventors: Toshiya Kamei, Gamagori (JP); Yukiyasu Itaya, Gamagori (JP)

Correspondence Address: BEYER WEAVER LLP, P.O. BOX 70250, OAKLAND, CA, 94612-0250, US

(21) Appl. No.: 11/485,054

(22) Filed: Jul. 11, 2006

(30) Foreign Application Priority Data
Mar. 27, 2006 (JP) 2006-84457

(51) Int. Cl. B32B 27/32; B05D 7/00

(52) U.S. Cl. 428/523; 427/407.1

(57) ABSTRACT

A laminated packaging film includes a contacting layer that is for coming to contact objects to be packaged inside and is formed with a polyolefin resin composition made of a polyolefin resin containing a specified component by a specified ratio. Another specified component is applied to the contacting surface of this contacting layer at a specified rate such that the contacting layer has improved antifog, smoothness and heat-sealing properties.

Priority is claimed on Japanese Patent Application 2006-84457 filed Mar. 27, 2006.

### BACKGROUND OF THE INVENTION

This invention relates to a laminated packing film and a method of producing such a film.

In recent years, laminated films made of a synthetic resin material are coming to be widely used for packaging food materials such as vegetables, meats, fresh fishes and side dishes. In particular among them, laminated films with a film layer contacting the packaged objects formed with a polyolefin resin composition are frequently being used. Such a packaging film is required to have transparency and antifog properties such that the packaged objects can be clearly visible from outside. As the packaging operation comes to be automated and faster, smoothness and heat-sealing property are also coming to be required. The present invention relates to an improved laminated packaging film that can satisfy all such requirements, as well as a method of producing such a film.

As example of the film layer of a laminated packaging film that comes to contact the packaged material, it has been known to mold a mixture of a partial ester of aliphatic alcohol and aliphatic acid with a compound of sulfonic acid or a polyolefin resin composition containing polyglycerol esters of fatty acids (as disclosed in Japanese Patent Publication Tokkai 2005-238791 and US Patent Publication 2005-0136275), to form with a polyolefin resin and thereafter apply an antifog agent containing glycerol monoaliphatic ester on its surface (such as disclosed in Japanese Patent Publication Tokkai 11-222531), and further to form with a polyolefin resin composition containing polyglycerol esters of fatty acids and thereafter apply sucrose fatty acid ester on its surface (such as disclosed in Japanese Patent Publication Tokkai 11-322980).

These prior art packaging films, however, have the problem that the film layer that comes to contact the packaged objects cannot sufficiently satisfy the requirement regarding the antifog, smoothness and heat-sealing properties without adversely affecting their natural transparency property.

### SUMMARY OF THE INVENTION

It is therefore an object of this invention to provide a laminated packaging film having a film layer that comes into contact with objects to be packaged formed with a polyolefin resin composition such that the film layer that comes to contact the packaged objects will simultaneously possess superior antifog, smoothness and heat-sealing properties without adversely affecting its natural transparency property, as well as a method of producing such a laminated packaging film.

The present invention is based on the discovery made by the present inventors as a result of their diligent studies in view of the aforementioned problems of the prior art. What is appropriate according to this discovery is to form the film layer of a laminated packaging film that comes to contact packaged objects by forming it with a polyolefin resin composition with a polyolefin resin containing a specified component at a specified ratio and applying a specified quantity of the specified component on the surface to be contacted by the packaged objects.

The invention is also based on the discovery that it is appropriate to produce such a film by obtaining a specified laminated film and thereafter applying a specified quantity of a specified component on its surface that contacts the packaged objects.

### DETAILED DESCRIPTION OF THE INVENTION

The invention relates to a laminated packaging film having a film layer that comes to contact objects to be packaged (hereinafter referred to as the “contacting layer”) formed with a polyolefin resin composition characterized wherein the contacting layer is formed with a polyolefin resin composition with polyolefin resin containing Component A defined below by 0.05-1 mass % and Component B defined below is applied to a contact surface of the contacting layer by 5-80 mg/m².

The invention also relates to a method of producing a laminated packaging film characterized as comprising the steps of preparing a laminated film having a film layer that serves to contact objects to be packaged and is formed with a polyolefin resin composition containing aforementioned Component A and thereafter applying aforementioned Component B on a surface for contacting objects to be packaged (hereinafter referred to as the contact surface).

In the above, Component A is defined as one or more selected from partial esters of polyhydric (trihydric-dodecahydric) aliphatic alcohol and aliphatic monocarboxylic acid with 8-22 carbon atoms, alkali salts of alkyl sulfonic acid having alkyl group with 6-22 carbon atoms, alkali salts of alkyl aryl sulfonic acid having alkyl group with 2-22 carbon atoms and alkali salts of 1,2-bis(alkyloxycarbonyl)-1-ethane sulfonic acid having alkyl group with 2-22 carbon atoms, and Component B is defines as one or more selected from partial esters of trihydric-tetrahydric aliphatic alcohol and aliphatic monocarboxylic acid with 8-22 carbon atoms, alkyl diethanol amines with 8-22 carbon atoms, alkyl diethanol amides with 8-22 carbon atoms and ester compounds of alkyl diethanol amine with 8-22 carbon atoms and aliphatic monocarboxylic acid with 8-22 carbon atoms.

One of the characteristics of the laminated packaging film of this invention is that its contacting layer is formed with a polyolefin resin composition with polyolefin resin containing Component A and that Component B is applied onto its contact surface.

Examples of polyolefin resin that may be used for the polyolefin resin composition forming the contacting layer include (1) α-olefin homopolymers such as polyethylene and polypropylene, obtainable from one selected from α-olefins with 2-8 carbons atoms such as ethylene, propylene, 1-butene and 1-hexene, 4-methylpentene-1,1-octene; (2) α-olefin copolymers such as ethylene-propylene copolymers, ethylene-(1-butene) copolymers and ethylene-(1-hexene) copolymers, obtainable from two or more selected from α-olefins with 2-8 carbon atoms as described above; and (3) copolymers obtainable from ethylene and vinyl acetate. Of the above, α-olefin homopolymers of (1) and α-olefin copolymers of (2) are preferable. Among the α-olefin copolymers of aforementioned (2), copolymers of ethylene and α-olefin with 4-8 carbon atoms having 2-50 mass % of units consisting of α-olefins with 4-8 carbon atoms are preferable. Such α-olefin copolymers are each preferably obtainable by a gas phase method or a solution polymerization method by using a known kind of homogenous catalyst such as a high activated ziegler catalyst or metallocene catalyst, and those with density in the range of 0.86-0.94 g/cm³ and MFR in the range of 0.01-20 g/10 minutes are particularly preferable. Two or more kinds of polyolefin resin shown about may be mixed together to be used.

Examples of Component A that is used for the polyolefin resin composition for forming the contacting layer include (1) partial esters of polyhydric (trihydric-dodecahydric) aliphatic alcohol and aliphatic monocarboxylic acid with 8-22 carbon atoms; (2) alkali salts of alkyl sulfonic acid having alkyl group with 6-22 carbon atoms; (3) alkali salts of alkyl aryl sulfonic acid having alkyl group with 2-22 carbon atoms; (4) alkali salts of 1,2-bis(alkyloxycarbonyl)-1-ethane sulfonic acid having alkyl group with 2-22 carbon atoms; and (5) mixtures of two or more of (1)-(4) above.

Examples of polyhydric (trihydric-dodecahydric) aliphatic alcohol for obtaining a partial ester serving as Component A as described above include glycerol, trimethylol propane, pentaerithritol, glucose, sorbitan, diglycerol, ethyleneglycol diglycerylether, triglycerol, trimethylol propane diglycerylether, sorbitol, tetraglycerol, dipentaerithritol, hexaglycerol, octaglycerol and decaglycerol. Examples of aliphatic monocarboxylic acid with 8-22 carbon atoms also for obtaining a partial ester serving as Component A as described above include octanoic acid, decanoic acid, tetradecanoic acid, octadecanoic acid, eicosanoic acid, tetradecenoic acid, octadecenoic acid, eicosenoic acid, isooctadecanoic acid and 12-hydroxy octadecanoic acid.

The partial esters serving as Component A are obtained by appropriately combining polyhydric (trihydric-dodecahydric) aliphatic alcohol and aliphatic monocarboxylic acid with 8-22 carbon atoms as explained above and each contain one free hydroxyl group in the molecule. Among these, partial esters obtained from polyhydric (trihydric-dodecahydric) aliphatic alcohol and aliphatic monocarboxylic acid with 12-18 carbon atoms are preferable and those obtained from polyglycerol having a condensation degree of 2 to 10 and aliphatic monocarboxylic acid with 12-18 carbon atoms are more preferable. Specific examples of such partial ester include diglycerol monostearate, triglycerol monopalmitate, tetraglycerol monopalmitate, tetraglycerol monooleate, hexaglycerol monolaurate, hexaglycerol monomyristate and decaglycerol monolaurate.

Examples of alkali salt of alkyl sulfonic acid having alkyl group with 6-22 carbon atoms serving as Component A include lithium hexyl sulfonate, lithium octyl sulfonate, sodium decyl sulfonate, sodium dodecyl sulfonate, sodium tetradecyl sulfonate, sodium hexadecyl sulfonate, sodium octadecyl sulfonate, potassium eicosyl sulfonate and potassium docosyl sulfonate. Among these, alkali salts of alkyl sulfonic acid having alkyl group with 12-18 carbon atoms are preferable.

Examples of alkali salt of alkyl aryl sulfonic acid having alkyl group with 2-22 carbon atoms serving as Component A include sodium ethyl benzene sulfonate, sodium propyl benzene sulfonate, sodium butyl benzene sulfonate, sodium dodecyl benzene sulfonate, potassium octadecyl benzene sulfonate, potassium eicosyl benzene sulfonate and sodium dibutyl naphthalene sulfonate. Among these, alkali salts of alkyl aryl sulfonic acid having alkyl group with 8-18 carbon atoms are preferable.

Examples of alkali salts of 1,2-bis(alkyloxycarbonyl)-1-ethane sulfonic acid having alkyl group with 2-22 carbon atoms serving as Component A include sodium 1,2-bis(ethyloxycarbonyl)-1-ethane sulfonate, sodium 1,2-bis(propyloxycarbonyl)-1-ethane sulfonate, sodium 1,2-bis(octyloxycarbonyl)-1-ethane sulfonate, lithium 1,2-bis(dodecyloxycarbonyl)-1-ethane sulfonate and lithium 1,2-bis(eicosyloxycarbonyl)-1-ethane sulfonate. Among these, alkali salts of 1,2-bis(alkyloxycarbonyl)-1-ethane sulfonic acid having alkyl group with 4-18 carbon atoms are preferable.

Explanation given above has been regarding Component A. Among these, partial esters of polyhydric (trihydric-dodecahydric) aliphatic alcohol and aliphatic monocarboxylic acid with 12-18 carbon atoms and alkali salts of alkyl sulfonic acid having alkyl group with 12-18 carbon atoms are preferable, and partial esters of polyglycerol having a condensation degree of 2 to 10 and aliphatic monocarboxylic acid with 12-18 carbon atoms are more preferable. Specific examples of such partial ester include diglycerol monostearate, tryglycerol monopalmitate, tetraglycerol monopalmitate, tetraglycerol monooleate, hexaglycerol monolaurate, hexaglycerol monomyristate and decaglycerol monolaurate.

A laminated packaging film embodying this invention has a contacting layer for contacting objects to be packaged formed by a polyolefin resin composition with a polyolefin resin containing Component A as explained above in an amount of 0.05-1 mass %, or preferably 0.1-0.6 mass %.

The polyolefin resin composition that forms the contacting layer may further contain agents of different kinds, depending on its purpose. Examples of such other agents that may be additionally contained include thermal stabilizer, antioxidant, neutralizer, lubricant, weatherproof agent, ultraviolet light absorber and anti-blocking agent but it is preferable to minimize the content of these additional agents.

The polyolefin resin composition that forms the contacting layer can be prepared by a known method such as (1) the method of placing Component A and polyolefin resin in a mixing machine such as a tumbler blender or a henschel mixer to mix together, preparing master pellets containing Component A at a high ratio by melting and mixing this mixture by means of an extruder such as a single-spindle extruder or a multiple-spindle extruder and further mixing these master pellets with a polyolefin resin to obtain a specified polyolefin resin composition; and (2) the method of placing polyolefin resin and Component A in a mixing machine such as a tumbler blender or a henschel mixer to mix together, melting and mixing them to produce particles by means of a kneader, a single-spindle extruder or a multiple-spindle extruder and obtaining a specified polyolefin resin composition.

The contacting layer of a laminated packaging film of this invention before Component B is applied thereon can be obtained by a known method. Examples of such prior art method include inflation molding methods such as air-cooling single step inflation molding, air-cooling two-step inflation molding and water-cooling inflation molding, and T die molding methods using a straight-through manifold die, a coat hanger die and a T die combining these. Examples of method for laminating films thus molded include dry laminate process, sandwich laminate process, extrusion laminate process and co-extrusion laminate process. Of these, the dry laminate process and co-extrusion laminate process are preferable. In these laminate methods, a polyurethane adhesive, an organotitanium anchor coat agent, an isocyanate anchor coat agent and an adhesive resin may be used, if necessary. Of these, a polyurethane adhesive is preferable. For obtaining a laminated packaging film of this invention, what has been obtained as explained above may be further subjected to a drawing process. Examples of such drawing process include the sequential biaxial orientation, simultaneous biaxial orientation and tubular biaxial orientation.

As explained above, the contacting layer of a laminated packaging film of this invention is formed with polyolefin resin composition containing Component A, and Component B is further applied to its contact surface for contacting objects to be packaged.

Examples of Component B to be applied to the contact surface include (1) partial esters of trihydric or tetrahydric aliphatic alcohol and aliphatic monocarboxylic acid with 8-22 carbon atoms; (2) alkyl diethanol amines with 8-22 carbon atoms; (3) alkyl diethanol amides with 8-22 carbon atoms; (4) ester compounds of alkyl diethanol amine with 8-22 carbon atoms and aliphatic monocarboxylic acid with 8-22 carbon atoms; and (5) mixtures of two or more of (1)-(4) above.

Examples of trihydric or tetrahydric aliphatic alcohol for obtaining the partial esters of trihydric or tetrahydric aliphatic alcohol and aliphatic monocarboxylic acid with 8-22 carbon atoms serving as Component B include glycerol, trimethylol propane, pentaerithritol, glucose, sorbitan, diglycerol and ethylene glycol diglycerylether. Examples of aliphatic monocarboxylic acid with 8-22 carbon atoms also for obtaining the partial ester include octanoic acid, dodecanoic acid, tetradecanoic acid, octadecanoic acid, eicosanoic acid, tetradecenoic acid, octadecenoic acid, eicosenoic acid, isooctadecanoic acid and 12-hydroxy octadecanoic acid. These partial esters serving as Component B are obtained as an appropriate combination of trihydric or tetrahydric aliphatic alcohol and aliphatic monocarboxylic acid with 8-22 carbon atoms as explained above and each contain one free hydroxyl group in the molecule. Among these, partial esters obtained from trihydric or tetrahydric aliphatic alcohol and aliphatic monocarboxylic acid with 12-18 carbon atoms are preferable and those obtained from glycerol or diglycerol and aliphatic monocarboxylic acid with 12-18 carbon atoms are more preferable. Examples of such partial ester include glycerol monooleate, diglycerol monolaurate, diglycerol monostearate and diglycerol monooleate.

Examples of alkyl diethanol amine with 8-22 carbon atoms serving as Component B include caprilyl diethanol amine, capryl diethanol amine, lauryl diethanol amine, myristyl diethanol amine, palmityl diethanol amine, stearyl diethanol amine and behenyl diethanol amine. Among these, alkyl diethanol amines having alkyl group with 12-18 carbon atoms are preferable.

Examples of alkyl diethanol amide with 8-22 carbon atoms serving as Component B include caprilyl diethanol amide, capryl diethanol amide, lauryl diethanol amide, myristyl diethanol amide, palmityl diethanol amide, stearyl diethanol amide and behenyl diethanol amide. Among these, alkyl diethanol amides having alkyl group with 12-18 carbon atoms are preferable.

The alkyl diethanol amines with 8-22 carbon atoms and aliphatic monocarboxylic acids with 8-22 carbon atoms, ester that form an ester compound serving as Component B are as explained above. Among such ester compounds, those of alkyl diethanol amine with 8-18 carbon atoms and aliphatic monocarboxylic acid with 12-22 carbon atoms are preferable and monoester compounds of alkyl diethanol amine with 8-18 carbon atoms and aliphatic monocarboxylic acid with 12-22 carbon atoms are more preferable.

Among the different kinds of Component B described above, partial esters obtained from trihydric or tetrahydric aliphatic alcohol and aliphatic monocarboxylic acid with 12-18 carbon atoms are preferable and those obtained from glycerol or diglycerol and aliphatic monocarboxylic acid with 12-18 carbon atoms are more preferable. Examples of such partial ester include glycerol monooleate, diglycerol monolaurate, diglycerol monostearate and diglycerol monooleate.

The amount of Component B to be applied to the contact surface of a laminated packaging film of this invention is preferably 5-80 mg/m² (for each side) and more preferably 10-60 mg/m².

Component B may be applied to the contact surface by a conventionally known method such as the spray coating method, gravure coating method, air knife coating method, bar coating method, kiss-roll coating method, flow coating method and dip coating method, each by using a coating liquid prepared by dissolving Component B in a solvent. Among the above methods, the gravure coating method is preferable. Examples of solvent for dissolving Component B include water, lower alcohols such as ethyl alcohol and isopropyl alcohol, toluene and ethyl acetate, either singly or as a mixture. Among the above, lower alcohols are preferable. In the coating liquid thus prepared by dissolving Component B in a solvent, the effective concentration of Compound B in the solvent is preferably 0.1-2 mass %.

Component B which is applied to the contact surface may contain other agents, depending on the purpose. Examples of such agents that may be contained by Component B include thermal stabilizers, antioxidants, neutralizers, lubricants, weatherproof agents, ultraviolet light absorbers, and anti-blocking agents, but it is preferable to minimize the content of these additional agents.

The invention also relates to a method of producing a laminated packaging film embodying this invention as described above. A laminated packaging film of this invention can be produced by forming its contacting layer with a polyolefin resin composition containing Component A, applying Component B to its contact surface and obtaining a laminated film by using such a film layer. According to a method of this invention, however, in order to form the contact layer and the obtain the laminated film efficiently, the contact layer is prepared by using a polyolefin resin composition containing Component A, and after producing a laminated film by using the contact layer thus obtained, or after producing a laminated film having a contacting layer formed with a polyolefin resin composition containing Component A, applying Component to its contact surface.

Component A, the polyolefin resin composition, Component B and its application are as described above. The method of forming the contacting layer by using a polyolefin resin composition containing Component A and the method of producing a laminated film using such a contacting layer are also as described above. It is preferable to use the inflation or T die molding method to form the contacting layer and to use the dry laminate or coextrusion process for producing the laminated film.

The present invention has the merit of providing a contacting layer of a laminated packaging film that is superior in the antifog, smoothness and heat-sealing properties without adversely affecting its natural transparency property.

The invention will be described next by way of examples in order to show its effects more clearly but it goes without saying that they are not intended to limit the scope of the invention. In what follows, “part” will indicate “mass part” and “%” will indicate “mass %”.

Part 1 (Production of Laminated Packaging Films)

### TEST EXAMPLE 1

After 90 parts of ethylene-(1-butene) copolymer (with ethylene copolymerization ratio=95%, density=0.920 g/cm³ and MFR=2.1 g/10 minutes) (E-1) and 10 parts of decaglycerol monolaurate (A-1) were placed inside a tumbler blender and mixed together, they were further melted and mixed by means of a double-spindle extruder to obtain master pellets. These master pellets (1.5 parts) and 98.5 parts of aforementioned ethylene-(1-butene) copolymer (E-1) were mixed together inside a tumbler blender to obtain a polyolefin resin composition for a contacting layer for contacting objects to be packaged. A molding process was carried out by a T die method while cooling to 30° C. such that aforementioned polyolefin resin composition would become one of external contacting layers for contacting objects to be packaged and aforementioned ethylene-(1-butene) copolymer (E-1) would become an internal film layer and the other external film layer to obtain a coextruded film of thickness 60 μm with three layers (with ratio of thickness 1/4/1). Next, after glycerol monooleate (0.4 part) was dissolved in isopropyl alcohol (99.6 parts) and a solution with the density of solid component 0.4% was applied by the gravure coating method to the contact surface of the aforementioned coextruded film with three layers at a rate of 10 g/m² (or 40 mg/m² if converted to solid component) per side, it was dried at 70° C. to obtain a laminated packaging film.

### TEST EXAMPLES 2-16 AND COMPARISON EXAMPLES 1-8

Laminated packaging films of Test Examples 2-16 and Comparison Examples 1-8 were similarly obtained. Details of these films are shown in Table 1.

TABLE 1

| | Component A | | Component B | | Kind of resin | | |
|---|---|---|---|---|---|---|---|
| | | Content | | Rate | forming each film layer | | |
| | Kind | (%) | Kind | (mg/m²) | *1 | *2 | *3 |
| Test | | | | | | | |
| Example | | | | | | | |
| 1 | A-1 | 0.15 | B-1 | 40 | E-1 | E-1 | E-1 |
| 2 | A-2 | 0.30 | B-2 | 10 | E-2 | E-1 | E-1 |
| 3 | A-3 | 0.55 | B-3 | 50 | E-3 | E-1 | E-1 |
| 4 | A-4 | 0.40 | B-4 | 55 | E-4 | E-1 | E-1 |
| 5 | A-5 | 0.40 | B-5 | 40 | E-1 | E-1 | E-1 |
| 6 | A-6 | 0.40 | B-6 | 40 | E-2 | E-1 | E-1 |
| 7 | A-7 | 0.40 | B-7 | 40 | E-3 | E-1 | E-1 |
| 8 | A-8 | 0.10 | B-8 | 40 | E-5 | E-1 | E-1 |
| 9 | A-9 | 0.40 | B-9 | 55 | E-6 | E-1 | E-1 |
| 10 | A-10 | 0.90 | B-10 | 50 | E-7 | E-1 | E-1 |
| 11 | A-11 | 0.90 | B-11 | 50 | E-1 | E-1 | E-1 |
| 12 | A-12 | 0.50 | B-12 | 50 | E-1 | E-1 | E-1 |
| 13 | A-13 | 0.07 | B-13 | 70 | E-1 | E-1 | E-1 |
| 14 | A-14 | 0.40 | B-14 | 5 | E-1 | E-1 | E-1 |
| 15 | A-15 | 0.90 | B-15 | 10 | E-1 | E-1 | E-1 |
| 16 | A-16 | 0.70 | B-16 | 20 | E-1 | E-1 | E-1 |
| Comparison | | | | | | | |
| Example | | | | | | | |
| 1 | — | — | B-1 | 40 | E-1 | E-1 | E-1 |
| 2 | a-1 | 0.15 | B-1 | 40 | E-1 | E-1 | E-1 |
| 3 | a-2 | 0.15 | B-1 | 40 | E-1 | E-1 | E-1 |
| 4 | a-3 | 0.15 | B-1 | 40 | E-1 | E-1 | E-1 |
| 5 | A-1 | 0.15 | — | — | E-1 | E-1 | E-1 |
| 6 | A-1 | 0.15 | b-1 | 40 | E-1 | E-1 | E-1 |
| 7 | A-1 | 0.15 | b-2 | 40 | E-1 | E-1 | E-1 |
| 8 | A-1 | 0.15 | b-3 | 40 | E-1 | E-1 | E-1 |

In Table 1:
*1: External film layer which is a polyolefin resin composition containing Component A with content as shown in Table 1 and is on one side for contacting objects to be packaged;
*2: Internal film layer;
*3 External film layer on the other side;
A-1: Decaglycerol monolaurate;
A-2: Hexaglycerol monomyristate;
A-3: Diglycerol monostearate;
A-4: Triglycerol monopalmitate;
A-5: Tetraglycerol monooleate;
A-6: Mixture at mass ratio 50/50 of diglycerol monostearate and tetraglycerol monooleate;
A-7: Mixture at mass ratio 50/50 of diglycerol monostearate and hexaglycerol monolaurate;
A-8: Glycerol monostearate;
A-9: Sorbitan monostearate;
A-10: Sodium dodecyl sulfonate
A-11: Sodium octadecyl sulfonate;
A-12: Mixture at mass ratio 50/25/25 of diglycerol monostearate, sodium tetradecyl sulfonate and sodium hexadecyl sulfonate;
A-13: Glycerol monobehenate;
A-14: Decaglycerol monocaprilate;
A-15: Sodium dodecyl benezene sulfonate;
A-16: Sodium 1,2-bis(octyloxycarbonyl)-1-ethane sulfonate;
a-1: Dodecyl diethanol amine;
a-2: Stearyl diethanol amide;
a-3: Ester of stearyl diethanol amine and stearic acid (monoester content 70%);
B-1: Glycerol monooleate;
B-2: Diglycerol monolaurate;
B-3: Diglycerol monostearate;
B-4: Diglycerol monooleate;
B-5: Mixture at mass ratio 50/50 of glycerol monooleate and diglycerol monolaurate;
B-6: Mixture at mass ratio 50/50 of glycerol monooleate and diglycerol monostearate;
B-7: Mixture at mass ratio 50/50 of glycerol monooleate and diglycerol monooleate;
B-8: Sorbitan monolaurate;
B-9: Sorbitan monooleate;
B-10: Mixture at mass ratio 50/50 of glycerol monooleate and sorbitan monolaurate;
B-11: Mixture at mass ratio 50/50 of diglycerol monolaurate and sorbitan monooleate;
B-12: Mixture at mass ratio 50/50 of diglycerol monostearate and sorbitan monooleate;
B-13: Diglycerol monocaprilate;
B-14: Dodecyl diethanol amine;
B-15: Stearyl diethanol amide;
B-16: Ester of stearyl diethanol amine and stearic acid (monoester content 70%);
b-1: Hexaglycerol monolaurate;
b-2: Sucrose laurate;
b-3: Ethylene oxide (10 mole) adduct of dodecyl alcohol;
E-1: Ethylene-(1-butene) copolymer (with ethylene copolymerization ratio = 95%, density = 0.920 g/cm³ and MFR = 2.1 g/10 minutes);
E-2: Ethylene-(1-hexene) copolymer (with ethylene copolymerization ratio = 96%, density = 0.926 g/cm³ and MFR = 1.0 g/10 minutes);
E-3: Ethylene-(1-octene) copolymer (with ethylene copolymerization ratio = 96%, density = 0.931 g/cm³ and MFR = 2.8 g/10 minutes);
E-4: Polyethylene (density = 0.927 g/cm³ and MFR = 4.0 g/10 minutes);
E-5: Ethylene-vinyl acetate copolymer (with ethylene copolymerization ratio = 82%, density = 0.93 g/cm³ and MFR = 1.5 g/10 minutes);
E-6: Ethylene-propylene copolymer (with ethylene copolymerization ratio = 4%, density = 0.90 g/cm³ and MFR = 8.0 g/10 minutes);
E-7: Polypropylene (density = 0.90 g/cm³ and MFR = 2.4 g/10 minutes).

Part 2 (Evaluation of Laminated Packaging Films)

The laminated packaging films produced in Part 1 were evaluated by the methods to be described below regarding their antifog property, smoothness and heat-sealing property as well as their transparency. Regarding the antifog property, smoothness and heat-sealing property, the side of the contacting layer to be contacted by objects to be packaged was treated as the measurement surface. The results of measurements are shown in Table 2.

Antifog Property

After the laminated packaging films prepared in Part 1 were each adjusted under the condition of relative humidity 65% for 24 hours at 20° C., a beaker containing water at 20° C. was covered with each film such that the measurement surface will face inside and left for one hour in an environment of temperature at 5° C. Water drops which became attached to the measurement surface were observed and evaluated as follows. Similar evaluations were made on the films kept for 4 weeks at 40° C. under the condition of relative humidity of 50%.

A: Transparent without water drops (excellent antifog property)

B: Transparent although with large water drops (good antifog property)

C: Somewhat non-transparent with water drops (poor antifog property)

D: Not transparent with small water drops (very poor antifog property)

Smoothness

After the laminated packaging films prepared in Part 1 were each adjusted under the condition of relative humidity 65% for 24 hours at 20° C., a friction tester (Type TR produced by Toyo Seiki Seisakusho, Ltd.) was used to measure the coefficient of kinetic friction according to JIS-K7125 and the measured values were evaluated as follows. Similar evaluations were made on the films kept for 4 weeks at 40° C. under the condition of relative humidity of 50%.

A: Less than 0.25 (excellent smoothness)

B: 0.25 or greater and less than 0.35 (good smoothness)

C: 0.35 or greater and less than 0.45 (poor smoothness)

D: 0.45 or greater (very poor smoothness and not practical)

Heat-Sealing Property

After the laminated packaging films prepared in Part 1 were adjusted under the condition of relative humidity 65% for 24 hours at 20° C., they were each heat-sealed by means of an impulse-type rice sealer produced by Shiga Hosokisha (with graduation setting=2.9). An elongated rectangular portion (15 mm×4 mm) was cut out, including the sealed portion and an autograph (AG-A produced by Shimadzu Corporation) to carry out a T-peel test to measure the force necessary for peeling off the heat-sealed portion. The measured values were evaluated as follows. Similar evaluations were made on the films kept for 4 weeks at 40° C. under the condition of relative humidity of 50%.

A: Over 8N/15 mm (excellent heat-sealing property)

B: 5N/15 mm or greater and less than 8N/15 mm (good heat-sealing property)

C: 3N/15 mm or greater and less than 5N/15 mm (poor heat-sealing property)

D: Less than 3N/15 mm (very poor heat-sealing property and not practical)

Transparency Property

After the laminated packaging films prepared in Part 1 were each adjusted under the condition of relative humidity 65% for 24 hours at 20° C., haze was measured and evaluated according to the following standards. Similar evaluations were also made on the films kept for 4 weeks under the condition of relative humidity 50% at 40° C.

A: Less than 5% (excellent transparency)

B: 5% or greater but less than 10% (good transparency)

C: 10% or greater but less than 15% (poor transparency)

D: 15% or greater (very poor transparency)

TABLE 2

| | | | | | Heat-sealing | | | |
|---|---|---|---|---|---|---|---|---|
| | Antifog property | | Smoothness | | property | | Transparency | |
| | After 24 | After 4 | After 24 | After 4 | After 24 | After 4 | After 24 | After 4 |
| | hours | weeks | hours | weeks | hours | weeks | hours | weeks |
| Test | | | | | | | | |
| Example | | | | | | | | |
| 1 | A | A | A | A | A | A | A | A |
| 2 | A | A | A | A | A | A | A | A |
| 3 | A | A | A | A | A | A | A | A |
| 4 | A | A | A | A | A | A | A | A |
| 5 | A | A | A | A | A | A | A | A |
| 6 | A | A | A | A | A | A | A | A |
| 7 | A | A | A | A | A | A | A | A |
| 8 | A | B | A | A | A | A | A | A |
| 9 | A | B | A | A | A | A | A | A |
| 10 | A | A | A | A | B | B | A | A |
| 11 | A | A | A | A | B | B | A | A |
| 12 | A | A | A | A | B | B | A | A |
| 13 | B | B | A | A | B | A | A | A |
| 14 | B | B | A | A | B | A | A | A |
| 15 | A | B | A | A | B | B | A | A |
| 16 | B | B | A | A | B | B | A | A |
| Comparison | | | | | | | | |
| Example | | | | | | | | |
| 1 | B | D | C | D | A | A | A | A |
| 2 | D | D | A | A | A | A | A | A |
| 3 | D | D | A | A | A | A | A | A |
| 4 | D | D | A | A | A | A | A | A |
| 5 | D | D | D | D | A | A | A | A |
| 6 | B | B | A | A | D | D | A | A |
| 7 | B | B | A | A | D | D | A | A |
| 8 | B | B | A | A | D | D | A | A |

Part 3 (Production of Laminated Packaging Films)

### TEST EXAMPLE 17

After 90 parts of ethylene-(1-butene) copolymer (E-1) as used in Test Example 1 of Part 1 and 10 parts of decaglycerol monolaurate (A-1) were placed inside a tumbler blender and mixed together, they were further melted and mixed by means of a double-spindle extruder to obtain master pellets. These master pellets (1.5 parts) and 98.5 parts of aforementioned ethylene-(1-butene) copolymer (E-1) were mixed together inside a tumbler blender to obtain a polyolefin resin composition for a contacting layer for contacting objects to be packaged. A molding process was carried out by a T die method while cooling to 30° C. such that aforementioned polyolefin resin composition would become one of external contacting layers for contacting objects to be packaged and aforementioned ethylene-(1-butene) copolymer (E-1) would become an internal film layer and the other external film layer to obtain a coextruded film of thickness 60 μm with three layers (with ratio of thickness 1/4/1). A polyurethane adhesive (obtained by preparing a mixture of Takelac A-615 and Takenate A-65 (both of Takeda Pharmaceutical Company Limited) at mass ratio of 16/1 with ethyl acetate such that the density of solid component would become 20%) was applied to a base film (biaxially oriented polyamide film with thickness 15 μm) (P-1) at a rate of 3 g/m² (converted to solid component) and after it was dried, it was pasted to the other external film layer of the aforementioned coextruded film with three layers by means of a nip roll and the polyurethane adhesive was hardened by leaving it for 24 hours at 50° C. Next, after glycerol monooleate (0.4 part) was dissolved in isopropyl alcohol (99.6 parts) and a solution with the density of solid component 0.4% was applied by the gravure coating method to the contact surface (where objects to be packaged are coming to contact) of the aforementioned coextruded film with three layers at a rate of 10 g/m² (or 40 mg/m² if converted to solid component) per side, it was dried at 70° C. to obtain a laminated packaging film.

### TEST EXAMPLES 18-32 AND COMPARISON EXAMPLES 9-16

Laminated packaging films of Test Examples 18-32 and Comparison Examples 9-16 were similarly obtained as in Test Example 17. Details of these films are shown in Table 3.

TABLE 3

| | Component A | | Component B | | Kind of resin forming each film layer | | | |
|---|---|---|---|---|---|---|---|---|
| | | Content | | Rate | Three-layered coextruded film | | | Base |
| | Kind | (%) | Kind | (mg/m²) | *1 | *2 | *3 | film |
| Test | | | | | | | | |
| Example | | | | | | | | |
| 17 | A-1 | 0.15 | B-1 | 40 | E-1 | E-1 | E-1 | P-1 |
| 18 | A-2 | 0.30 | B-2 | 10 | E-2 | E-1 | E-1 | P-1 |
| 19 | A-3 | 0.55 | B-3 | 50 | E-3 | E-1 | E-1 | P-1 |
| 20 | A-4 | 0.40 | B-4 | 55 | E-4 | E-1 | E-1 | P-2 |
| 21 | A-5 | 0.40 | B-5 | 40 | E-1 | E-1 | E-1 | P-2 |
| 22 | A-6 | 0.40 | B-6 | 40 | E-2 | E-1 | E-1 | P-3 |
| 23 | A-7 | 0.40 | B-7 | 40 | E-3 | E-1 | E-1 | P-3 |
| 24 | A-8 | 0.10 | B-8 | 40 | E-5 | E-1 | E-1 | P-1 |
| 25 | A-9 | 0.40 | B-9 | 55 | E-6 | E-1 | E-1 | P-1 |
| 26 | A-10 | 0.90 | B-10 | 50 | E-7 | E-1 | E-1 | P-2 |
| 27 | A-11 | 0.90 | B-11 | 50 | E-1 | E-1 | E-1 | P-2 |
| 28 | A-12 | 0.50 | B-12 | 50 | E-1 | E-1 | E-1 | P-3 |
| 29 | A-13 | 0.07 | B-13 | 70 | E-1 | E-1 | E-1 | P-1 |
| 30 | A-14 | 0.40 | B-14 | 5 | E-1 | E-1 | E-1 | P-2 |
| 31 | A-15 | 0.90 | B-15 | 10 | E-1 | E-1 | E-1 | P-2 |
| 32 | A-16 | 0.70 | B-16 | 20 | E-1 | E-1 | E-1 | P-3 |
| Comparison | | | | | | | | |
| Example | | | | | | | | |
| 9 | — | — | B-1 | 40 | E-1 | E-1 | E-1 | P-3 |
| 10 | a-1 | 0.15 | B-1 | 40 | E-1 | E-1 | E-1 | P-1 |
| 11 | a-2 | 0.15 | B-1 | 40 | E-1 | E-1 | E-1 | P-1 |
| 12 | a-3 | 0.15 | B-1 | 40 | E-1 | E-1 | E-1 | P-1 |
| 13 | A-1 | 0.15 | — | — | E-1 | E-1 | E-1 | P-1 |
| 14 | A-1 | 0.15 | b-1 | 40 | E-1 | E-1 | E-1 | P-1 |
| 15 | A-1 | 0.15 | b-2 | 40 | E-1 | E-1 | E-1 | P-1 |
| 16 | A-1 | 0.15 | b-3 | 40 | E-1 | E-1 | E-1 | P-1 |

In Table 3:
P-1: Biaxially oriented polyamide film (thickness = 15 μm);
P-2: Biaxially oriented polyethylene terephthalate film (thickness = 12 μm);
P-3: Biaxially oriented polypropylene film (thickness = 20 μm with both surfaces treated by corona discharge 38 μN/cm);
Other symbols are as defined for Table 1.

Part 4 (Evaluation of Packaging Films)

The packaging films prepared in Part 3 were evaluated as done in Part 2 regarding their antifog property, smoothness, heat-sealing property and transparency. Regarding the antifog property, smoothness and heat-sealing property, the measuring surface was the surface on the side of the contact surface for contacting objects to be packaged. The results are summarized in Table 4.

TABLE 4

| | | | | | Heat-sealing | | | |
|---|---|---|---|---|---|---|---|---|
| | Antifog property | | Smoothness | | property | | Transparency | |
| | After 24 | After 4 | After 24 | After 4 | After 24 | After 4 | After 24 | After 4 |
| | hours | weeks | hours | weeks | hours | weeks | hours | weeks |
| Test | | | | | | | | |
| Example | | | | | | | | |
| 17 | A | A | A | A | A | A | B | B |
| 18 | A | A | A | A | A | A | B | B |
| 19 | A | A | A | A | A | A | B | B |
| 20 | A | A | A | A | A | A | B | B |
| 21 | A | A | A | A | A | A | B | B |
| 22 | A | A | A | A | A | A | B | B |
| 23 | A | A | A | A | A | A | B | B |
| 24 | A | B | A | A | A | A | B | B |
| 25 | A | B | A | A | A | A | B | B |
| 26 | A | A | A | A | B | B | B | B |
| 27 | A | A | A | A | B | B | B | B |
| 28 | A | A | A | A | B | B | B | B |
| 29 | B | B | A | A | B | A | B | B |
| 30 | B | B | A | A | B | A | B | B |
| 31 | A | B | A | A | B | B | B | B |
| 32 | B | B | A | A | B | B | B | B |
| Comparison | | | | | | | | |
| Example | | | | | | | | |
| 9 | B | D | C | D | A | A | B | B |
| 10 | D | D | A | A | A | A | B | B |
| 11 | D | D | A | A | A | A | B | B |
| 12 | D | D | A | A | A | A | B | B |
| 13 | D | D | D | D | A | A | B | B |
| 14 | B | B | A | A | D | D | B | B |
| 15 | B | B | A | A | D | D | B | B |
| 16 | B | B | A | A | D | D | B | B |

Part 5 (Production of Laminated Packaging Films)

### TEST EXAMPLE 33

After 90 parts of ethylene-(1-butene) copolymer (E-1) as used in Test Example 1 of Part 1 and 10 parts of decaglycerol monolaurate (A-1) were placed inside a tumbler blender and mixed together, they were further melted and mixed by means of a double-spindle extruder to obtain master pellets. These master pellets (1.5 parts) and 98.5 parts of aforementioned ethylene-(1-butene) copolymer (E-1) were mixed together inside a tumbler blender and provided to an inflation molding machine (TKN-40 produced by Chubu Kagaku Kikai Seisakusho, Inc.) having a die of 75 mmø and lip interval of 0.5 mm attached to it to carry out an inflation molding process under the condition of resin extrusion temperature=200° C. and BUR=1.8 to obtain a single-layer film with thickness 40 μm. After a polyurethane adhesive (obtained by preparing a mixture of Takelac A-615 and Takenate A-65 (both of Takeda Pharmaceutical Company Limited) at mass ratio of 16/1 with ethyl acetate such that the density of solid component would become 20%) was applied to the same base film (P-1) described above in Test Example 17 of Part 2 at a rate of 3 g/m² (converted to solid component) and after it was dried, it was pasted to the aforementioned single-layer film with this applied surface sandwiched in between by means of a nip roll and the polyurethane adhesive was hardened by leaving it for 24 hours at 50° C. Next, after glycerol monooleate (0.4 part) was dissolved in isopropyl alcohol (99.6 parts) and a solution with the density of solid component 0.4% was applied by the gravure coating method to the contact surface (where objects to be packaged are coming to contact) of the aforementioned single-layer film at a rate of 10 g/m² (or 40 mg/m² if converted to solid component) per side, it was dried at 70° C. to obtain a laminated packaging film.

### TEST EXAMPLES 34-48 AND COMPARISON EXAMPLES 17-24

Laminated packaging films of Test Examples 34-48 and Comparison Examples 17-24 were similarly obtained as in Test Example 33. Details of these films are shown in Table 5.

TABLE 5

| | | | | | Kind of resin | |
|---|---|---|---|---|---|---|
| | | | | | forming each film layer | |
| | Component A | | Component B | | Single- | |
| | | Content | | Rate | layer | |
| | Kind | (%) | Kind | (mg/m²) | film | Base film |
| Test | | | | | | |
| Example | | | | | | |
| 33 | A-1 | 0.15 | B-1 | 40 | E-1 | P-1 |
| 34 | A-2 | 0.30 | B-2 | 10 | E-2 | P-1 |
| 35 | A-3 | 0.55 | B-3 | 50 | E-3 | P-1 |
| 36 | A-4 | 0.40 | B-4 | 55 | E-4 | P-2 |
| 37 | A-5 | 0.40 | B-5 | 40 | E-1 | P-2 |
| 38 | A-6 | 0.40 | B-6 | 40 | E-2 | P-3 |
| 39 | A-7 | 0.40 | B-7 | 40 | E-3 | P-3 |
| 40 | A-8 | 0.10 | B-8 | 40 | E-5 | P-1 |
| 41 | A-9 | 0.40 | B-9 | 55 | E-6 | P-1 |
| 42 | A-10 | 0.90 | B-10 | 50 | E-7 | P-2 |
| 43 | A-11 | 0.90 | B-11 | 50 | E-1 | P-2 |
| 44 | A-12 | 0.50 | B-12 | 50 | E-1 | P-3 |
| 45 | A-13 | 0.07 | B-13 | 70 | E-1 | P-1 |
| 46 | A-14 | 0.40 | B-14 | 5 | E-1 | P-2 |
| 47 | A-15 | 0.90 | B-15 | 10 | E-1 | P-2 |
| 48 | A-16 | 0.70 | B-16 | 20 | E-1 | P-3 |
| Comparison | | | | | | |
| Example | | | | | | |
| 9 | — | — | B-1 | 40 | E-1 | P-3 |
| 10 | a-1 | 0.15 | B-1 | 40 | E-1 | P-1 |
| 11 | a-2 | 0.15 | B-1 | 40 | E-1 | P-1 |
| 12 | a-3 | 0.15 | B-1 | 40 | E-1 | P-1 |
| 13 | A-1 | 0.15 | — | — | E-1 | P-1 |
| 14 | A-1 | 0.15 | b-1 | 40 | E-1 | P-1 |
| 15 | A-1 | 0.15 | b-2 | 40 | E-1 | P-1 |
| 16 | A-1 | 0.15 | b-3 | 40 | E-1 | P-1 |

In Table 5: Symbols are as defined for Table 3.

Part 6 (Evaluation of Packaging Films)

The packaging films prepared in Part 5 were evaluated as done in Part 2 regarding their antifog property, smoothness, heat-sealing property and transparency. Regarding the antifog property, smoothness and heat-sealing property, the measuring surface was the surface on the side of the contact surface for contacting objects to be packaged. The results are summarized in Table 6.

TABLE 6

| | | | | | Heat-sealing | | | |
|---|---|---|---|---|---|---|---|---|
| | Antifog property | | Smoothness | | property | | Transparency | |
| | After 24 | After 4 | After 24 | After 4 | After 24 | After 4 | After 24 | After 4 |
| | hours | weeks | hours | weeks | hours | weeks | hours | weeks |
| Test | | | | | | | | |
| Example | | | | | | | | |
| 33 | A | A | A | A | A | A | B | B |
| 34 | A | A | A | A | A | A | B | B |
| 35 | A | A | A | A | A | A | B | B |
| 36 | A | A | A | A | A | A | B | B |
| 37 | A | A | A | A | A | A | B | B |
| 38 | A | A | A | A | A | A | B | B |
| 39 | A | A | A | A | A | A | B | B |
| 40 | A | B | A | A | A | A | B | B |
| 41 | A | B | A | A | A | A | B | B |
| 42 | A | A | A | A | B | B | B | B |
| 43 | A | A | A | A | B | B | B | B |
| 44 | A | A | A | A | B | B | B | B |
| 45 | B | B | A | A | B | A | B | B |
| 46 | B | B | A | A | B | A | B | B |
| 47 | A | B | A | A | B | B | B | B |
| 48 | B | B | A | A | B | B | B | B |
| Comparison | | | | | | | | |
| Example | | | | | | | | |
| 17 | B | D | C | D | A | A | B | B |
| 18 | D | D | A | A | A | A | B | B |
| 19 | D | D | A | A | A | A | B | B |
| 20 | D | D | A | A | A | A | B | B |
| 21 | D | D | D | D | A | A | B | B |
| 22 | B | B | A | A | D | D | B | B |
| 23 | B | B | A | A | D | D | B | B |
| 24 | B | B | A | A | D | D | B | B |

What is claimed is:

1. A laminated packaging film including a contacting layer of a polyolefin resin composition having a contact surface that comes to contact objects to be packaged in said packaging film, said polyolefin resin composition comprising polyolefin resin containing Component A by 0.05-1 mass %, Component B being applied on said contact surface of said contacting layer at a rate of 5-80 mg/m²;
wherein said Component A is one or more selected from the group consisting of partial esters of trihydric-dodecahydric aliphatic alcohol and aliphatic monocarboxylic acid with 8-22 carbon atoms, alkali salts of alkyl sulfonic acid having alkyl group with 6-22 carbon atoms, alkali salts of alkyl aryl sulfonic acid having alkyl group with 2-22 carbon atoms and alkali salts of 1,2-bis(alkyloxycarbonyl)-1-ethane sulfonic acid having alkyl group with 2-22 carbon atoms; and
wherein said Component B is one or more selected from the group consisting of partial esters of trihydric-tetrahydric aliphatic alcohol and aliphatic monocarboxylic acid with 8-22 carbon atoms, alkyl diethanol amines with 8-22 carbon atoms, alkyl diethanol amides with 8-22 carbon atoms and ester compounds of alkyl diethanol amine with 8-22 carbon atoms and aliphatic monocarboxylic acid with 8-22 carbon atoms.

2. The laminated packaging film of claim 1 wherein said Component A is one or more selected from the group consisting of partial esters of trihydric-dodecahydric aliphatic alcohol and aliphatic monocarboxylic acid with 12-18 carbon atoms, and alkali salts of alkyl sulfonic acid having alkyl group with 12-18 carbon atoms.

3. The laminated packaging film of claim 1 wherein said Component A is one or more selected from the group consisting of partial esters of glycerine condensate having a condensation degree of 2 to 10 and aliphatic monocarboxylic acid with 12-18 carbon atoms.

4. The laminated packaging film of claim 3 wherein said Component B is one or more selected from the group consisting of partial esters of trihydric or tetrahydric aliphatic alcohol and aliphatic monocarboxylic acid with 12-18 carbon atoms.

5. The laminated packaging film of claim 3 wherein said Component B is one or more selected from the group consisting of partial esters of glycerol or diglycerol and aliphatic monocarboxylic acid with 12-18 carbon atoms.

6. The laminated packaging film of claim 3 wherein the polyolefin resin of said polyolefin resin composition is ethylene homopolymer or a copolymer of ethylene and α-olefin with 4-8 carbon atoms.

7. The laminated packaging film of claim 5 wherein the polyolefin resin of said polyolefin resin composition is ethylene homopolymer or a copolymer of ethylene and α-olefin with 4-8 carbon atoms.

8. A method of producing a laminated packaging film, said method comprising the steps of:
preparing a laminated film having a contacting film layer that serves to contact objects to be packaged and is formed with a polyolefin resin composition containing Component A and thereafter applying Component B over a contact surface of said contacting film layer for contacting objects to be packaged at a rate of 5-80 mg/m²;
wherein said Component A is one or more selected from the group consisting of partial esters of trihydric-dodecahydric aliphatic alcohol and aliphatic monocarboxylic acid with 8-22 carbon atoms, alkali salts of alkyl sulfonic acid having alkyl group with 6-22 carbon atoms, alkali salts of alkyl aryl sulfonic acid having alkyl group with 2-22 carbon atoms and alkali salts of 1,2-bis(alkyloxycarbonyl)-1-ethane sulfonic acid having alkyl group with 2-22 carbon atoms; and
wherein said Component B is one or more selected from the group consisting of partial esters of trihydric-tetrahydric aliphatic alcohol and aliphatic monocarboxylic acid with 8-22 carbon atoms, alkyl diethanol amines with 8-22 carbon atoms, alkyl diethanol amides with 8-22 carbon atoms and ester compounds of alkyl diethanol amine with 8-22 carbon atoms and aliphatic monocarboxylic acid with 8-22 carbon atoms.

9. The method of claim 8 wherein said Component A is one or more selected from the group consisting of partial esters of glycerine condensate having a condensation degree of 2 to 10 and aliphatic monocarboxylic acid with 12-18 carbon atoms.

10. The method of claim 9 wherein said Component B is one or more selected from the group consisting of partial esters of glycerol or diglycerol and aliphatic monocarboxylic acid with 12-18 carbon atoms.

11. The method of claim 9 wherein the polyolefin resin of said polyolefin resin composition is ethylene homopolymer or a copolymer of ethylene and α-olefin with 4-8 carbon atoms.

12. The method of claim 10 wherein the polyolefin resin of said polyolefin resin composition is ethylene homopolymer or a copolymer of ethylene and α-olefin with 4-8 carbon atoms.

13. The method of claim 11 wherein said contacting film layer is formed by an inflation molding or T die molding method.

14. The method of claim 12 wherein said contacting film layer is formed by an inflation molding or T die molding method.

15. The method of claim 13 wherein said laminated film is produced by a dry laminating or coextrusion method.

16. The method of claim 14 wherein said laminated film is produced by a dry laminating or coextrusion method.
